(19) United States
(12) Patent Application Publication
(10) Pub. No.: US 2001/0037333 A1
(43) Pub. Date: Nov. 1, 2001

(54) Asset information management method, asset information management system, asset information identifier database, and data structure of asset information management identifier

(75) Inventor: Shuichi Nishimura, Kasugai-shi (JP)

Correspondence Address: OLIFF & BERRIDGE, PLC, 277 S. WASHINGTON STREET, SUITE 500, ALEXANDRIA, VA, 22314, US

(73) Assignee: TOYOTA JIDOSHA KABUSHIKI KAISHA

(21) Appl. No.: 09/833,762

(22) Filed: Apr. 13, 2001

(30) Foreign Application Priority Data
Apr. 17, 2000 (JP) 2000-115408
Jan. 15, 2001 (JP) 2001-6959

(51) Int. Cl. G06F 17/30

(52) U.S. Cl. 707/9

(57) ABSTRACT

In each customer database, different kinds of asset information are registered so as to be retrieved using the different customer managing number as retrieval data. In an integrated identification information database, the customer managing number of the customer database is registered to constitute the integrated identification information under the association with the integrated ID as an identifier unique to each customer. A database integrating and managing section and the like integrates and manages the customer database based on the customer managing number associated with the integrated ID of the integrated identification information database. This arrangement makes it possible to easily integrate and manage a plurality of kinds of the asset information respectively registered in the different databases.

### INCORPORATION BY REFERENCE

The disclosure of Japanese Patent Application Nos. 2000-115408 filed on Apr. 17, 2000, and 2001-6959 filed on Jan. 15, 2001 including the specification, drawings and abstract is incorporated herein by reference in its entirety.

### BACKGROUND OF THE INVENTION

1. Field of the Invention

The invention relates to management of asset information registered in a database.

2. Description of Related Art

In an asset information management system using a database, the asset information of a specific customer is retrieved from asset information data registered in the database, using retrieval data such as keywords, for example, the customer number issued to each customer for the asset information management.

The aforementioned asset information management system is widely used in many tasks such as financial operations so as to manage various kinds of asset information. For example, an account number is used as a keyword in banking business, a credit card number is used as the keyword in credit card business, and different kinds of keywords are used in different systems to manage the asset information registered in each database.

Conventionally, processing asset information data of a plurality of databases in an integrated manner, e.g., processing different kinds of asset information registered in a plurality of databases in a relational manner or collectively processing those asset information data has been unavoidably complicated and troublesome.

In order to process those data in an integrated manner, it is necessary to access different kinds of asset information data registered in the different databases. Therefore, whenever information of each customer is processed, it is necessary to prepare a different keyword for each kind of the asset information. For example, in order to process a specific customer's asset information concerning a credit card and banking in the integrated manner, the customer's credit card number and bank account number will be required as keywords. Thus, processing of those different kinds of information data of the same customer requires a plurality of different kinds of codes, resulting in complicated procedure for the integrated processing.

### SUMMARY OF THE INVENTION

The invention has been accomplished in view of the foregoing circumstances, and it is an object of the invention to simplify an integrated management of different kinds of asset information data registered in a plurality of different databases.

According to the first aspect of the invention, in an asset information management method of managing different kinds of asset information of a customer, each of the different kinds is registered in a corresponding database among a plurality of databases in which different types of retrieval data are used for retrieving information concerning the customer. The method includes the steps of establishing integrated identification information in which the different types of retrieval data used in the respective databases are associated with an identifier unique to the customer, and integrating and managing the different kinds of asset information using the integrated identification information.

According to a preferred form of the first aspect of the invention, the retrieval data in each of the databases associated with the identifier is aquired from the integrated identification information based on the identifier unique to the customer, and a corresponding kind of asset information of the customer is retrieved from each database based on the retrieved data.

According to the second aspect of the invention, an asset information management system is provided with a plurality of databases in which different kinds of asset information is registered with respect to each customer, and different kinds of asset information is retrieved by using different types of retrieval data, an integrated identification information database which contains integrated identification information in which the retrieval data of the databases for said each customer are associated with an identifier unique to each customer and registered, and a database manager that integrates and manages the plurality of databases based on the retrieval data associated with the identifier used in the integrated identification information database.

According to the first and second aspects of the invention, if any of keywords of databases registered in the integrated identification information and at least one of identifiers unique to each customer, any keyword of each database can be obtained by referring to the integrated identification information, and each asset information of the respective database can be assessed. Therefore, it is possible to easily integrate and manage the asset information registered in the different database and retrieved by the different keyword. With this arrangement, various asset information data of customers separately managed in the different databases can be easily integrated and managed. Then it becomes possible to provide an easier asset management service with higher quality.

Here, the term “identifier unique to a customer” means the information such as a code, a number, a name, an address, a telephone number and a combination thereof, which serves to identify each customer. The term “retrieval data” or “keywords” means the information required for retrieving the asset information of a specific customer from asset information data registered in the database. In the database, the “identifier unique to a customer” is usually used as the “keyword” in many cases. In that case, the integrated identification information may be structured by defining any of the keywords of the databases as the identifier unique to a customer in the integrated identification information such that the keyword is associated with a keyword of another database.

According to the third aspect of the invention, in an integrated identification information database for asset information management, retrieval data for each customer, which are used in a plurality of databases in which different kinds of asset information is registered, are associated with the identifier unique to each customer, to provide integrated identification information.

According to the fourth aspect of the invention, in a data structure of integrated identification information for asset information management, retrieval data for each customer, which are used in a plurality of databases in which different kinds of asset information is registered, are associated with a single identifier unique to said each customer.

The asset information management integrated identification information database of the third aspect or the data structure of the asset information management integrated identification information of the fourth aspect may realize the asset information management performed by the method of the first aspect or the structure of the second aspect of the invention.

According to the fifth aspect of the invention, a computer readable recording medium records integrated identification information for use in asset information management, and the integrated identification information has a data structure in which retrieval data for each customer, which are used in a plurality of databases in which different kinds of asset information is registered, are associated with a single identifier unique to each customer.

The asset information management identification information recorded in a recording medium of the fifth aspect may realize the asset information management performed by the method of the first aspect or the structure of the second aspect of the invention.

### BRIEF DESCRIPTION OF THE DRAWINGS

The invention will be described in conjunction with the following drawings.

FIG. 1 is a schematic view showing a system structure of an asset information management of an embodiment of the invention;

FIG. 2 is a schematic view showing a data structure of an integrated identification information database;

FIG. 3 is a flowchart showing a processing procedure for providing internet service;

FIG. 4 is also a flowchart showing the processing procedure for providing internet service;

FIG. 5 is a schematic view showing one example of a log in screen;

FIG. 6 is a schematic view showing one example of a menu screen;

FIG. 7 is a schematic view showing one example of an asset information screen;

FIG. 8 is a schematic view showing another example of an asset information screen;

FIG. 9 is a schematic view showing a system structure of the asset information management of another embodiment of the invention; and

FIG. 10 is a flowchart showing a procedure for displaying the asset information at a time.

### DETAILED DESCRIPTION OF THE PREFERRED EMBODIMENTS

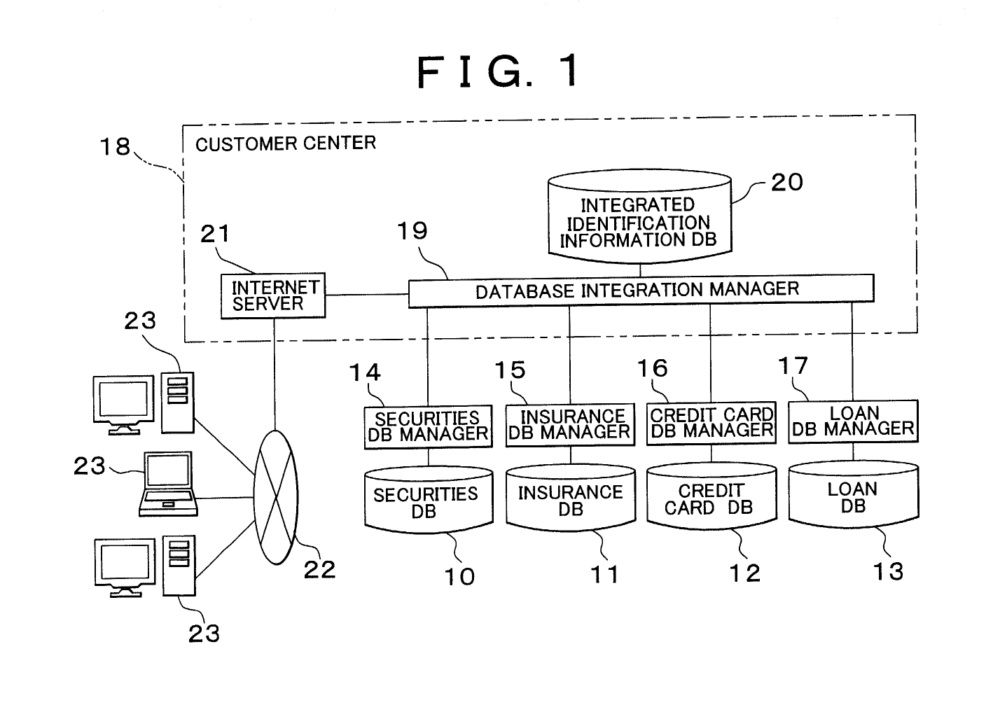

An embodiment of the invention will be explained in detail with reference to FIGS. 1 to 8.

As shown in FIG. 1, an asset information management system of the embodiment includes four customer databases (DB) 10 to 13 each of which registers asset information of securities, insurance, credit card and loan, respectively and database managers 14 to 17 for respectively managing the asset information registered in the customer databases 10 to 13. Each of the database managers 14 to 17 is formed as a computer system for executing management of each asset information registered in the databases 10 to 13.

In the securities database 10, asset information concerning securities (securities asset information), for example, the information concerning mutual fund balance on the account, deposit balance on the securities account, deposit/withdrawal record and the like is registered individually for each customer. The securities asset information is registered in the securities database 10 individually by the respective contracts of the securities management accounts. More specifically, the securities asset information is registered individually in the securities database 10 as one file in accordance with the account number of the securities management account.

The securities database manager 14 controls the securities asset information of the customer registered in the securities database 10 on the basis of the aforementioned account number. That is, the securities database manager 14 retrieves (accesses) the securities asset information of the customer concerned using the aforementioned account number as the keyword, and updates the information. For example, when the securities database manager 14 receives the deposit/withdrawal information of the securities management account from an automatic teller machine (ATM) connected through a dedicated line and a terminal provided in each branch, the securities database manager 14 accesses the securities asset information based on the account number included in the received deposit/withdrawal information, and updates the deposit balance and deposit/withdrawal record included in the securities asset information.

Asset information (insurance asset information) concerning insurance transaction such as information concerning contract of insurance is registered in an insurance database 11 for each customer. The insurance asset information is registered in the insurance database 11 for each insurance contract. The insurance database manager 15 accesses the insurance asset information of each insurance customer using the insurance number of the contracted insurance as the keyword, thus managing the information. The insurance database 11 may include a plurality of databases of different kinds of insurance such as automobile insurance, fire insurance, life insurance and the like, and a customer having a plurality of insurance is registered in the corresponding insurance database for each kind of insurance.

Asset information (credit card asset information) concerning credit card business such as a credit account and payment information of credit card loan. The credit card asset information is registered in the credit card database 12 for each credit card contract. The credit card database manager 16 accesses the credit card asset information of a credit card customer using the credit card number of the contracted credit card as the keyword, thus managing the information. The credit card database 12 may also include a plurality of databases of different kinds of credit card. The credit card asset information of a customer having contract of a different kinds of credit cards is registered in the corresponding credit card database for each credit card.

Asset information (loan asset information) concerning loan, for example, payment information of each object such as housing loan and automobile loan is registered in the loan database 13. The loan database manager 17 accesses the loan asset information of each loan customer using a loan contract number of the contracted loan as the keyword, thus managing the information.

The asset information of the customer databases 10 to 13 is retrieved using the customer managing number (account number, insurance number, credit card number, loan contract number) as the keyword, and the information is independently managed. Therefore, to access the asset information of the customer databases 10 to 13, even when accessing to the asset information of the same customer, different customer managing numbers must be prepared.

As explained above, the database managers 14 to 17 are connected to each other through a database integration manager 19 provided in a customer center 18 for providing support service of customer such as reply to an inquiry from a customer. The database integration manager 19 is formed as a computer system which serves to make those database managers 14 to 17 associated one another.

Connected to the database integration manager 19 is integrated identification information, i.e., integrated identification information database 20 in which information for integrating and managing the access to the asset information of the customer databases 10 to 13 is registered. Integrated identification information for managing the access to each asset information is registered by the customer in the integrated identification information database 20 under integrated ID as an identifier unique to each customer.

The integrated ID is issued only once to a new customer when the customer newly registered to at least one of the customer databases 10 to 13. The integrated ID is provided with different code for each customer, and the code is an identifier unique to each customer. The integrated ID is generated as a code having a different customer registration number of each asset information registered in the customer databases 10 to 13.

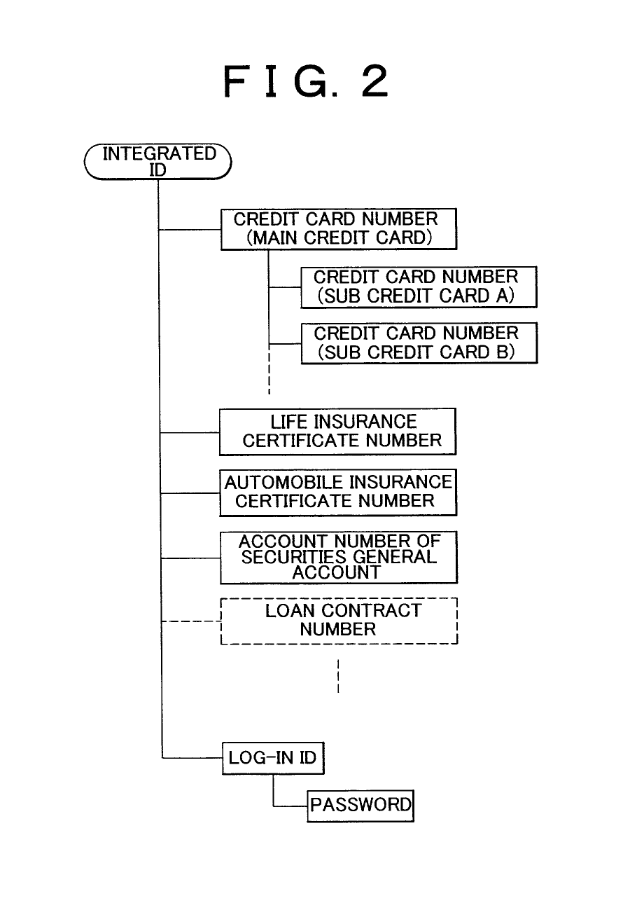

As shown in FIG. 2, in the integrated identification information database 20, a customer registration number (e.g., keyword of an account number of a securities managing account) for the corresponding customer of the customer databases 10 to 13 is registered in correspondence to the integrated ID. That is, the integrated identification information of each customer registered in the integrated identification information database 20 includes a customer registration number registered in each of the customer databases 10 to 13 for the customer under the integrated ID of the corresponding customer.

In the example shown in FIG. 2, an account number as a keyword of asset information (securities asset information) concerning securities management account to which the customer contracted, such as a life insurance number, an automobile insurance number and a credit card number which can be keyword of asset information concerning the life insurance, automobile insurance, and credit card are registered as the integrated identification information under the integrated ID of the customer. When a customer contracted in a plurality kinds of credit card, as shown in FIG. 2, a credit card number of other credit cards (a sub credit card A, a sub credit card B, . . . ) is associated with a credit card number of any main credit card and registered in the integrated identification information.

All the customer registration numbers of the customer databases 10 to 13 concerning the corresponding customer are registered in the integrated identification information of the integrated identification information database 20. Since any of the customer registration number of the integrated ID and each asset information are identifiers unique to the customer, it is possible to retrieve the integrated identification information of the customer. Therefore, if at least one of the integrated ID or customer registration number is found, it is possible to obtain the customer registration number of arbitrary asset information concerning the corresponding customer by referring to the integrated identification information.

With this arrangement, the database integration manager 19 and the like integrates and manages the access the asset information of the customer databases 10 to 13 using the customer registration number of each asset information obtained by referring to the integrated identification information of the integrated identification information database 20.

As an example of such integrating and managing method, a case in which insurance asset information concerning a customer A who is also a securities customer and insurance customer is referred to from a terminal provided in a securities office will be explained.

A request for referring to the information from the terminal of the securities office is sent to the securities database manager 14 connected through the dedicated line. When the request is made, an account number of the securities managing account of the customer A is informed to the database integration manager 19 from the terminal.

In reply to the request, the database integration manager 19 retrieves the integrated identification information of the customer A registered in the integrated identification information database 20 using the informed account number as the keyword, and obtains the insurance number which is the keyword of the integrated identification information for the customer A. Then, the database integration manager 19 retrieves the insurance asset information of the customer A from the insurance database 11 using the obtained insurance number to obtain the insurance asset information of the requesting customer A. Thereafter, the database integration manager 19 sends the obtained insurance asset information of the requesting customer A to the terminal of the securities office through the securities database manager 14. With this arrangement, it is possible to refer to the insurance asset information by the terminal in the securities office.

At that time, the database integration manager 19 functions as the database managing means. It is also possible that the securities database manager 14 carries out the processing of the database integration manager 19. In that case, the securities database manager 14 functions as the database managing means.

A data structure of the integrated identification information constructed in the above-described manner has high general versatility and expandability. For example, if the customer shown as the example of the integrated identification information is newly contract the loan, a new loan contract number is issued, and based on the loan contract number, the loan asset information of the customer is additionally registered in the loan database 13. At that time, as shown with broken line in FIG. 2, in the integrated identification information of the customer of the integrated identification information database 20, the loan contract number is associated with the integrated ID of the customer. With this arrangement, the loan asset information newly registered in the loan database 13 can be integrated and managed like the existing asset information of that customer. That is, based on the newly issued loan contract number, it is possible to access the asset the existing information of the customer registered in the other customer databases 10 to 12. Based on the customer registration number of the existing asset information, it is possible to access the loan asset information registered in the new loan database 13.

According to this embodiment, whenever a new customer registered to at least one of the customer databases 10 to 13, the customer registration number of the asset information is additionally registered to the integrated identification information of that customer, and the customer registration number is associated with the integrated ID. With this arrangement, even when the customer registration of the customer databases 10 to 13 is changed, it is possible to integrate and manage the asset information appropriately.

When the asset information registered in the customer databases 10 to 13 is eliminated in reply to cancellation of the contract, the customer registration number of the asset information is eliminated from the integrated identification information of that customer.

The data structure of the integrated identification information can easily accept new addition of a customer database integrated and managed by the database integration manager 19. For example, when a business range is enlarged due to creating a new business or due to partnership with another company, it is necessary to enlarge the range of integrated management of the database integration manager 19 so that the asset information of further customer database can be integrated and managed. The asset information of the new customer database to be added is usually constructed such that the asset information is retrieved using a keyword different from the keyword of the asset information registered in the customer database which is integrated and managed in many cases.

If the customer database is integrated and managed using the integrated identification information, in the above case also, the keyword of the customer database can be associated with the integrated identification information in the integrated identification information of that customer. Therefore, it is possible to enlarge the integrated management range while leaving the asset information registered in the existing customer database and the new customer database as they are. Thus, it is possible to suppress the maintenance costs required for enlarging the integrated management range.

As described above, by integrating and managing the customer databases 10 to 13 based on the integrated identification information, it becomes easy to access the various asset information, and it is possible to integrally process the various asset information including processing while associating the various asset information with each other, and processing the various asset information collectively at the same time. The data structure of the integrated identification information has high general versatility and expandability and, it is possible to integrating and managing the information appropriately while coping with the difference in structure between customer databases or between the asset information. It is possible to realize integrated finance service in a borderless manner between business.

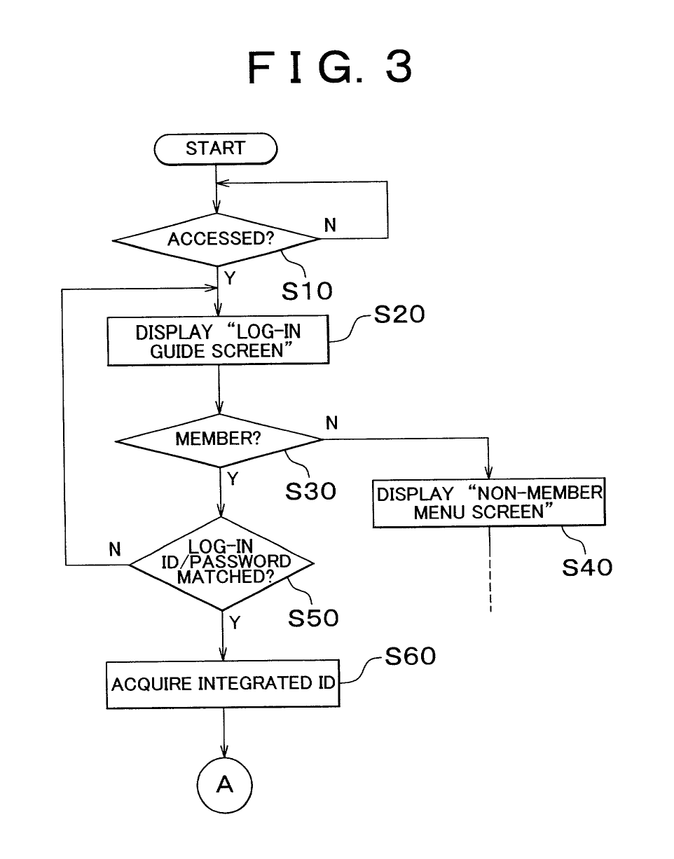

Subsequently, one example of the integrated management using the integrated identification information in an integrated finance service will be explained with reference to FIGS. 3 to 8 also. As shown in FIG. 1, the database integration manager 19 of this embodiment is further connected to the internet server 21 for providing service using an internet line 22. The internet server 21 sends image information to an external terminal 23 and displays on a display of the external terminal 23 in accordance from access from the external terminal 23 connected to the internet server 21 through the internet line 22. The internet server 21 is constructed as a Web server which sends Web page image information described using Web page language such as HTML to the external terminal 23.

As service (internet service) provided through the internet line 22, different is provided for a credit card member who is a credit card customer registered in the credit card database 12, and for non-member who is not a credit card customer. A log-in ID and a password unique to a member are previously issued to the credit card member (credit card customer). When accessed from the external terminal 23, the internet server 21 requires input of the log-in ID and the password. The log-in ID and the password are verified, the internet server 21 permits the access the Web page for providing service for the credit card member, and provides internet service while drawing a distinction between credit card member and non-member. The log-in ID is generated as a code different from the customer registration number of the asset information of the customer databases 10 to 13, and this is an identifier unique to a customer.

As shown in FIG. 2, the log-in ID and the password for a customer receiving the internet service are also registered in the integrated identification information of each customer in the integrated identification information database 20. In the internet server 21, in order to judge whether the access the Web page for the service for the credit card member is required or not, the log-in ID and the password are verified using the integrated identification information.

In this embodiment, the internet server 21 provides service for displaying the asset information of the customer included in the asset information registered in the customer databases 10 to 13 at a time. Using the integrated identification information, the internet server 21 retrieves asset information of that customer from the customer databases 10 to 13 which is required for the display service of the asset information at a time. In the processing using the integrated identification information, the internet server 21 functions as the database managing means.

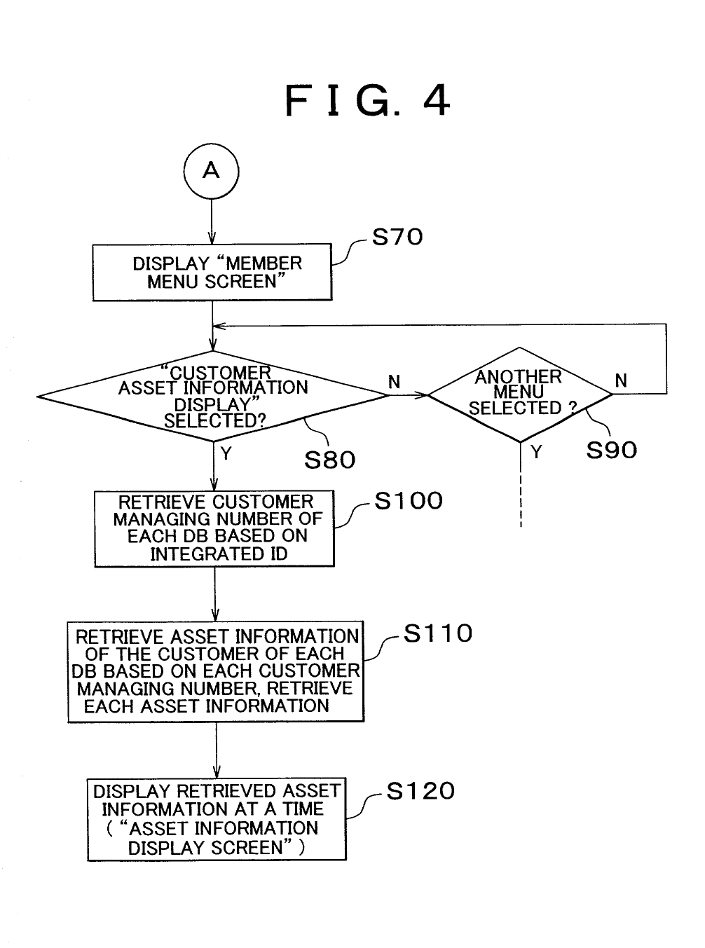

In the internet service, the processing from the access from the external terminal 23 to the display of the asset information on the display is carried out at a time along the procedure shown in flowcharts in FIGS. 3 and 4 for example. The procedure in the flowcharts in FIGS. 3 and 4 is carried out as continuous batch processing. However, in the actual case, whenever the operation such as a mouse click is carried out on a predetermined portion of the Web page, processing associated with the operation is carried out one by one sequentially.

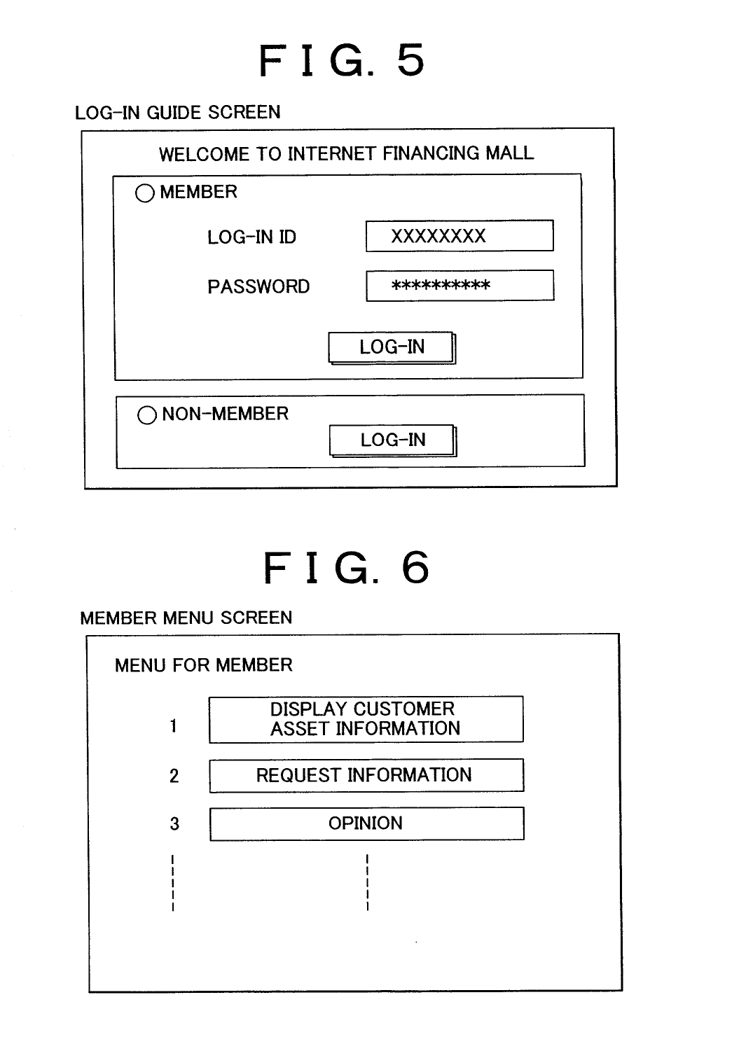

In the flowchart in FIG. 3, if YES in step 10, i.e., if the internet server 21 is accessed from the external terminal 23 through the internet line 22, the procedure is proceeded to step 20. Here, the internet server 21 sends Web page image information of “log-in guide screen” as shown in FIG. 5 for example to the external terminal 23, and displays the Web page image information of “log-in guide screen” on the display (explanation of detailed processing concerning the screen display will be omitted hereinafter, and it will be described as “screen is displayed” only).

In the “log-in guide screen”, “log-in button” for a member linked to a Web page for providing service for the credit card member and “log-in button” for non-member linked to a Web page for providing service for non-member are displayed. In the screen, input boxes for the log-in ID and the password used for judging the credit card member are displayed.

In a state in which the “log-in guide screen” is displayed, if NO in step 30, i.e., if operation such as the mouse click is carried out on the “log-in button” for the non-member in the external terminal 23, the internet server 21 proceeds to step 40, and “non-member menu screen” is displayed on the display of the external terminal 23. In the “non-member menu screen”, various menus linked to the Web page for providing service for non-member are displayed.

On the other hand, in a state in which the “log-in guide screen” is displayed, if YES in step 30, i.e., if operation such as mouse click is carried out on the “log-in button” for member in the external terminal 23, the internet server 21 proceeds to step 50. Here, it is judged whether it is necessary to access the Web page for providing service for credit card members. This judgment is made by identifying the log-in ID and password input into the input boxes with the log-in ID and the password constituting the integrated identification information registered in the integrated identification information database 20.

More specifically, the internet server 21 at that time sequentially accesses each integrated identification information registered in the integrated identification information database 20, and retrieves integrated identification information in which the log-in ID and password coinciding with the log-in ID and password input in the input boxes are registered.

If NO in step 50, i.e., if no integrated identification information is retrieved in the integrated identification information database 20, the internet server 21 displays a screen informing that the input log-in ID or password is wrong on the display of the external terminal 23 and then, displays the “log-in guide screen” again.

When YES in step 50, i.e., the integrated identification information in which the log-in ID and password identified with the log-in ID and password input in the input boxes are registered is retrieved, the internet server 21 proceeds to step 60. The integrated ID is obtained from the retrieved integrated identification information, and the procedure is proceeded to step 70 in FIG. 4. A “member menu screen” as shown in FIG. 6 is displayed on the display of the external terminal 23.

In the “member menu screen”, various menus linked to Web page concerning service for the credit card member is displayed. In the screen, “customer asset information display” is provided as one of the menus. The “customer asset information display” menu is linked to “asset information display screen” which is a Web page for providing service of display of the asset information of the customer at a time.

In a state in which the “member menu screen” is displayed, if NO in step 80 and YES in step 90, i.e., if operation such as mouse click is carried out on menus other than the “customer asset information display” menu, the internet server 21 display the Web page linked to the operated menu on the display of the external terminal 23.

In a state in which the “member menu screen” is displayed, if YES in step 80, i.e., if the operation such as mouse click is carried out on the “customer asset information display” menu, the internet server 21 proceeds to step 100 to carry out the following procedure.

In step 100, the internet server 21 again access the integrated identification information of the customer registered in the integrated identification information database 20 using the integrated ID of that customer obtained in step 60, and obtains the customer managing number of various asset information registered in the customer databases 10 to 13. Here, account number, insurance number, credit card number and loan contract number which are customer managing numbers of that customer are obtained from the integrated identification information of that customer.

The internet server 21 proceeds to step 110, where based on the obtained customer managing number, the internet server 21 accesses each asset information of that customer registered in the customer databases 10 to 13, and retrieves various asset information of that customer.

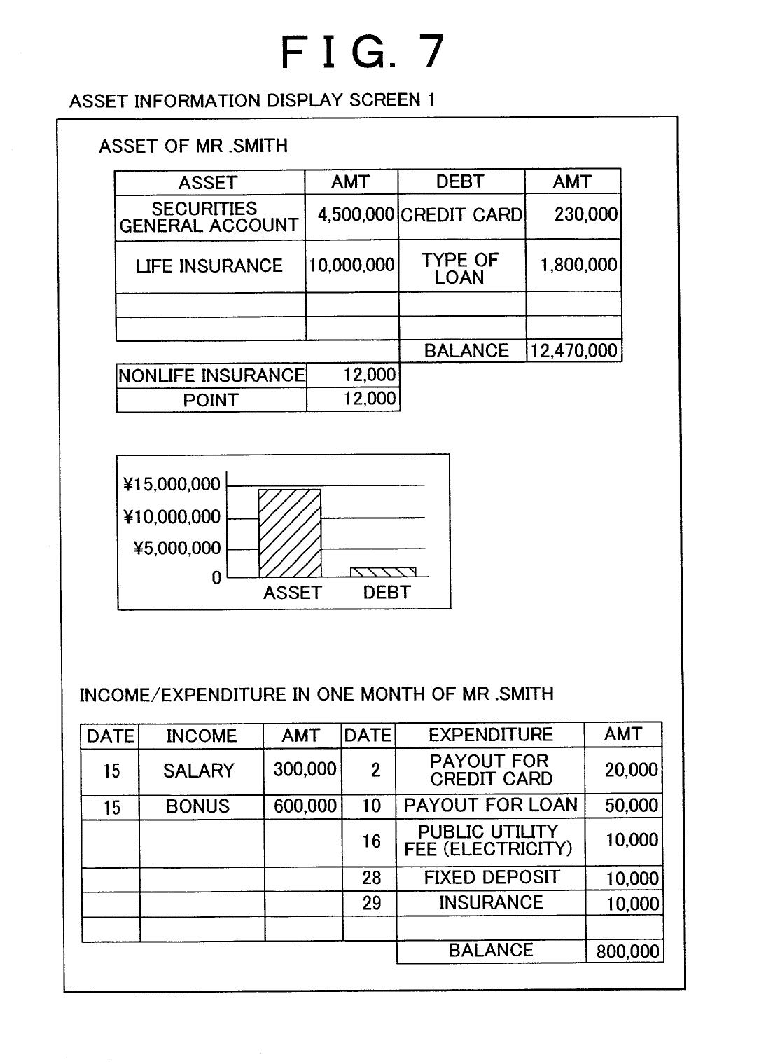

The internet server 21 further proceeds to step 120, where a Web page screen information for displaying the asset information of that customer at a time based on the obtained various asset information, and display an “asset information display screen 1” shown in FIG. 7 on the display of the external terminal 23.

The “asset information display screen 1”, a table indicating details of asset and debit of that customer, shows a graph of an amount of the asset and the debit, details income and spending of that customer constructed based on the information concerning transfer and payment of the securities management account of that customer with date. In this “asset information display screen 1”, portions on which the items of the table are displayed are linked to a Web page screen displaying detailed information of the corresponding item, and if operation such as mouse click is carried out on the portion of the item of the screen from the external terminal 23, it is possible to access the Web page displaying the detailed information.

As described above, in this embodiment, the internet server 21 verifies the log-in ID and password input from the external terminal 23 connected through the internet line 22 and the log-in ID and password of each integrated identification information registered in the integrated identification information database 20. When the input log-in ID and password are both registered in the integrated identification information database 20, the asset information of the customer databases 10 to 13 is retrieved using the customer managing number associated with the registered log-in ID, and the asset information of the customer is retrieved. With this operation, it is possible to retrieve each asset information without requiring complicated operation including input of customer managing number individually, and the operation becomes easy.

In the above processing, the internet server 21 functions as the database managing means. In this embodiment, the log-in ID and password are generated as codes different from the customer managing number of the customer databases 10 to 13. With this arrangement, it is possible to obtain each asset information retrieved by the customer managing number without informing the customer managing number through the internet line 22. Thus, it is possible to prevent the customer managing number including credit card number of credit card from being stolen on the internet line 22.

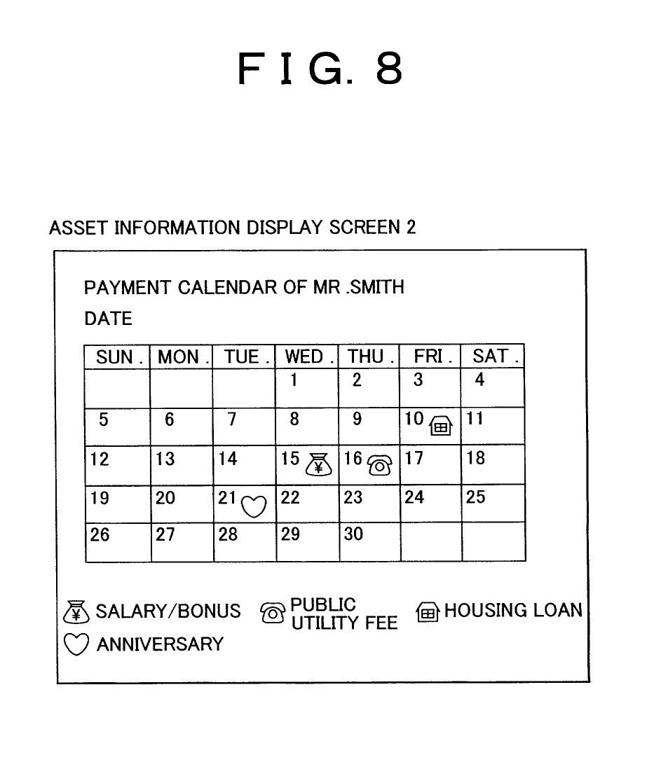

The Internet server 21 can also display a “asset information display screen 2” as shown in FIG. 8 on the display of the external terminal 23. In the “asset information display screen 2”, based on the asset information of the credit card retrieved by the same procedure as that described above, transfer data and payment date to the securities management account of the customer are displayed on a calendar. On the calendar, information concerning a memorial data of the customer such as a birth day and a renewal data of a driver's license or passport is displayed together with profile information of the customer obtained together with the retrieval of the asset information.

According to the embodiment explained above, the following effect can be obtained.

(1) In the embodiment, each integrated identification information registered in the customer databases 10 to 13 is managed integrally by the integrated identification information in which the customer managing number which is a keyword of each asset information is associated with the integrated ID. If at least one of the integrated ID or customer managing number registered in the integrated identification information is found, it is possible to obtain an arbitrary customer registration number registered in the integrated identification information, and it is possible to access any of the asset information of that customer. Therefore, it is possible to easily integrally manage different kinds of ass registered in different customer databases.

(2) In the embodiment, each customer managing number is managed in association with the integrated ID generated as a code different from the customer managing number, and whenever a new customer is registered with respect to at least one of the customer databases 10 to 13, the customer registration number of the asset information is further associated with the integrated ID in the integrated identification information. With this arrangement, even when the customer registration of the customer databases 10 to 13 is changed, it is possible to integrate and manage the asset information appropriately.

(3) In the embodiment, each asset information is integrated and managed using the integrated identification information constructed as a data structure having high general versatility and expandability. Thus, it is possible to integrating and managing the information appropriately while coping with the difference in structure between customer databases or between the asset information. It is possible to realize integrated service in a borderless manner between business.

(4) In the embodiment, the internet server 21 identifies the log-in ID and password input from the external terminal 23 with those registered in the integrated identification information database 20. When the input log-in ID and password are both registered in the integrated identification information database 20, the asset information of the customer databases 10 to 13 is retrieved using the customer managing number associated with the registered log-in ID, and the asset information of the customer is retrieved. This may provide each asset information of the customer with easy operation requiring no complicated operation, for example, individual input of the customer managing number.

(5) In the embodiment, the internet server 21 displays various kinds of the asset information of the customer retrieved and obtained at a time. Thus, it is possible to provide, with simple operation, service for displaying various kinds of the asset information included in the different asset information registered in the different customer databases 10 to 13. The integrated identification information allows the aforementioned service to be provided easily.

(6) In the embodiment, the internet server 21 displays various kinds of the asset information at a time on the display of the external terminal 23 connected through the internet line 22. The log-in ID for displaying the asset information at a time may be specified from the external terminal 23 connected through the internet line 22. This makes it possible to provide the service for displaying the asset information at a time through the internet.

(7) In the embodiment, the log-in ID and password specified through the internet line 22 are created as codes different from the customer managing numbers registered in the customer databases 10 to 13. This arrangement makes it possible to obtain each asset information retrieved by the customer managing number without informing those numbers through the internet line 22. Thus, it is possible to prevent the customer managing number such as the credit card number of credit card from being stolen on the internet line 22.

(8) In the embodiment, the asset information individually registered in the customer databases 10 to 13 is integrated and managed using the integrated identification information. With this arrangement, it is possible to provide the integrated asset management service such as the simple asset management service with high quality.

Other Embodiments

As explained above, by utilizing the integrated identification information registered in the integrated identification information database 20, it is possible to easily access any of the asset information of a customer managed under the different keywords (customer managing numbers) registered in the databases 10 to 13. With this arrangement, it is possible to easily integrate and manage the various kinds of the asset information registered individually in the different databases 10 to 13 as described above. The aforementioned management technique of the asset information may enhance various services in addition to those explained in the above embodiment.

One of the customer services provided by various financial institutions is known as the call service for responding to inquiries from customers over the phone. The technique for managing the asset information may be applied to make the call service prompt and appropriate.

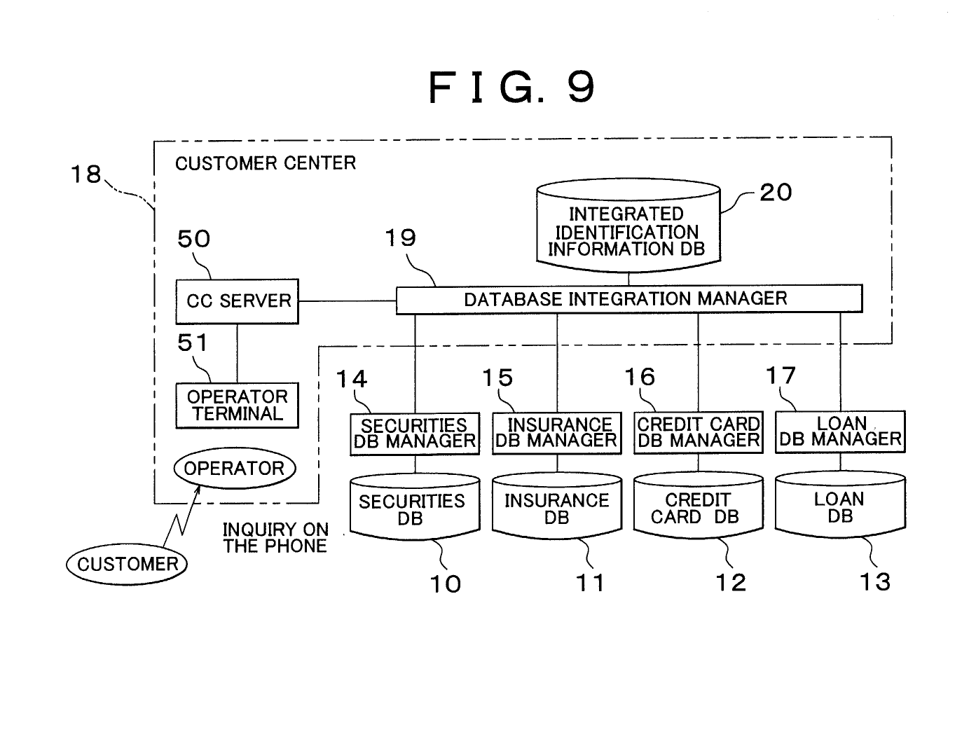

FIG. 9 shows one example of a system structure which makes the asset information management system applicable to the call service. Each operator responds to inquiries on the phone using a computer terminal 51. Each of the operator terminal 51 is connected to a server (cc server) 50 of the customer center through a LAN line. It is possible to access the database integration manager 19 through the CC server 50.

In response to the inquiry from a customer on the phone, the operator reads various kinds of the asset information of the customer into the terminal 51 of her/his own through the database integration manager 19 using the integrated ID of the customer. Then, the operator responds to the inquiry while displaying the screen of the asset information of the customer on the display at a time.

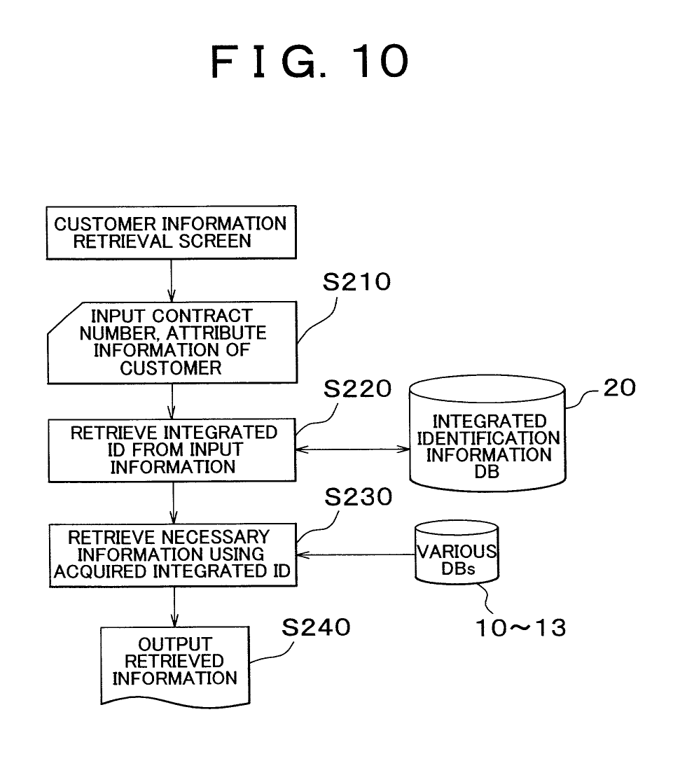

In this case, the integrated ID is a management number in the system, which has never been informed to the customer. However, the integrated ID may be easily and promptly obtained from the customer registration number of the respective financial services (account number, credit card number, etc.) using the information registered in the integrated identification information database 20. It is possible to easily and promptly obtain the integrated ID from the customer registration number of the financial service (such as account number and credit card number). FIG. 10 shows such processing procedure of the call of the asset information.

In this procedure, the operator displays a screen for retrieving customer information on her/his terminal 51. On the customer information retrieve screen, input columns to which attribute information of customer is input, for example, customer registration number, name, address and telephone number of each finance service are displayed. Next in step 210, in response to an arbitrary customer registration number of financial institutions requested by the customer, the number is input to the corresponding input column.

After the number is input for retrieving the customer information on the terminal 51, the process proceeds to step 220. The input customer registration number is, then, sent to the database integration manager 19 from the operator terminal 51. The database integration manager 19 retrieves the integrated ID of the customer from the integrated identification information database 20 using the customer registration number as the keyword, and sends the integrated ID to the operator terminal 51. In this manner, the integrated ID of the customer is displayed on the operator terminal 51.

When the customer does not remember his/her own customer registration number, the integrated ID of the customer may be retrieved by the attribute information of the customer such as the name, birthday, and phone number. Based on the retrieved integrated ID, the asset information can be obtained.

In step 230, the operator terminal 51 reads, if necessary, the asset information of the customer from the databases 10 to 13 through the database integration manager 19 using the obtained integrated ID. The thus read-out asset information is displayed on the display of the terminal 51 at a time.

The management technique of the asset information makes it possible to display required information of the asset information of the customer at a time easily and promptly and to respond the customer's inquiry while checking the information on the display. Accordingly the aforementioned call service may provide the customer with services more smoothly. The resultant call service may be further enhanced in terms of quality and quantity.

According to the aforementioned embodiment, the integrated ID is used only for managing the information in the system without informing the integrated ID to the customer. However, the system may be managed such that the integrated ID is preliminarily informed to the customer. In this case, when the customer gives his/her integrated ID from the beginning, the asset information can be called without carrying out the retrieving process in steps 210 and 220.

The embodiment may be modified as described below. According to the aforementioned embodiment, the log-in ID and password are verified to judge whether or not the customer is allowed to access the Web page for credit card members. The aforementioned judgment may be performed by identifying the log-in ID only. In this case, the password is formed as the code created through a predetermined function from the log-in ID code. Accordingly, the password can be verified by determining whether or not it has been formed as the code created through a predetermined function from the log-in ID code as described above.

According to the foregoing embodiment, it is judged whether or not the customer is allowed to access the Web page for credit card members using the log-in ID as the identifier unique to the customer created as a code different from the customer managing number of the respective asset information. Alternatively, the customer registration number or integrated ID of the customer databases 10 to 13 may be used for the aforementioned judgment so as to provide the same services.

According to the foregoing embodiment, the asset information displayed at a time may be provided upon the access from the external terminal 23 through the internet line 22. However, the same service may be provided upon the access from the terminal, for example, ATM, connected through the dedicated line.

According to the foregoing embodiment, the asset information of the customer is displayed at a time, which has been retrieved by identifying the log-in ID. However, it is possible to provide services in an arbitrary form other than the display of the asset information at a time. For example, asset management service may be provided by analyzing the thus retrieved asset information.

According to the foregoing embodiment, whenever a new customer is registered in at least one of the customer databases 10 to 13, the customer registration number of the asset information is further associated with the integrated ID to constitute the integrated identification information. In this case, the integrated ID in the form of the identifier has been created as a code different from the respective customer managing number as the keyword registered in the customer databases 10 to 13. The integrated identification information may be structured without using the integrated ID by associating any customer managing number of the customer databases 10 to 13 with other customer managing number. Even in the above case, the asset information of the customer having the customer managing number with which other number is associated may be integrated and managed.

Alternatively the attribute information of the customer such as the name, address, phone number and birthday may be associated with the integrated ID and registered in the integrated identification information database 20.

The attribute information of the customer may be managed only in the integrated identification information database 20. According to this modification, the attribute information of the customer is not directly managed in the customer databases 10 to 13. However, those databases are allowed to access the attribute information from the integrated identification information database 20 in case of necessity. In the case where the change in the attribute information of the customer is required accompanied with the change in the address, for example, the attribute information can be changed by only correcting the information data registered in the integrated identification information database 20.

The foregoing asset information management may further be applied to the system having an arbitrary structure in other than the asset information management system structured as described above. Technical idea derived from the aforementioned embodiment will be described below together with effect thereof.

It is possible to store, in a computer readable recording medium, asset information management integrated identification information having a data structure in which keywords classified by the customer of a plurality of databases having different kinds of asset information are registered is associated with one identifier. The asset information management according to the invention may be realized by the asset information management integrated identification information recorded in this recording medium.

In this case, the identifier is created as a code different from the keyword of the database. Whenever a new customer registration is performed with respect to at least one of the customer databases, the keyword of the corresponding asset information is associated with the identifier. The asset information management integrated identification information having the foregoing data structure stored in the recording medium makes it possible to construct integrated identification information as a flexible data structure having high versatility and expandability capable of appropriately integrating and managing the asset information while coping with the difference in the customer information structure between databases and changes of customer registration in the respective databases.

What is claimed is:

1. An asset information management method of managing different kinds of asset information of a customer, each of the different kinds being registered in a corresponding database among a plurality of databases in which different types of retrieval data are used for retrieving information concerning the customer, the method comprising the steps of:
establishing integrated identification information in which the different types of retrieval data used in the respective databases are associated with an identifier unique to the customer; and
integrating and managing the different kinds of asset information using the integrated identification information.

2. The method according to claim 1, wherein the retrieval data in each of the databases associated with the identifier is aquired from the integrated identification information based on the identifier unique to the customer, and a corresponding kind of asset information of the customer is retrieved from said each database based on the retrieved data.

3. The method according to claim 2, further comprising the step of displaying the different kinds of retrieved asset information of the customer in said each database at a time.

4. The method according to claim 2, wherein the identifier unique to the customer is matched with the retrieval data used in each of databases, and associated with the identifier, through a communication network.

5. The method according to claim 3, wherein the identifier unique to the customer is matched with the retrieval data used in each of databases, and associated with the identifier, through a communication network.

6. The method according to claim 1, wherein the identifier is created according to a code different from that of the retrieval data in said each database, and wherein
every time a new customer registration is performed in at least one of the databases, retrieval data for the asset information of the customer are newly associated with the identifier to constitute the integrated identification information.

7. The method according to claim 2, wherein the identifier is created according to a code different from that of the retrieval data in said each database, and wherein
every time a new customer registration is performed in at least one of the databases, retrieval data for the asset information of the customer are newly associated with the identifier to constitute the integrated identification information.

8. An asset information management system comprising:
a plurality of databases wherein different kinds of asset information is registered with respect to each customer, said different kinds of asset information being retrieved by using different types of retrieval data;
an integrated identification information database which contains integrated identification information in which the retrieval data of the databases for said each customer are associated with an identifier unique to said each customer and registered; and
a database manager that integrates and manages the plurality of databases based on the retrieval data associated with the identifier used in the integrated identification information database.

9. The asset information management system according to claim 8, wherein the database manager identifies an identifier that has been specified with one of the identifiers registered in the integrated identification information database, and when the specified identifier is registered in the integrated identifier information database, at least one of the plurality of databases is retrieved by using the retrieval data associated with the specified identifier, and the corresponding asset information is retrieved from said at least one of the databases.

10. The asset information management system according to claim 9, further comprising a display controller that displays the different kinds of retrieved asset information on a display device at a time.

11. The asset information management system according to claim 10, wherein the identifier is specified through a communication network, and the retrieved asset information is transmitted through the communication network and is displayed on the display device.

12. The asset information management system according to claim 8, wherein the identifier is created according to a code different from that of the retrieval data in said each database, and wherein
every time a new customer registration is performed in at least one of the databases, retrieval data for the asset information of the customer are newly associated with the identifier to constitute the integrated identification information.

13. The asset information management system according to claim 9, wherein the identifier is created according to a code different from that of the retrieval data in said each database, and wherein
every time a new customer registration is performed in at least one of the databases, retrieval data for the asset information of the customer are newly associated with the identifier to constitute the integrated identification information.

14. An integrated identification information database for asset information management, wherein retrieval data for each customer, which are used in a plurality of databases in which different kinds of asset information is registered, are associated with the identifier unique to said each customer, to provide integrated identification information.

15. The database according to claim 13, wherein the identifier is created according to a code different from that of the retrieval data in said each database, and wherein
every time a new customer registration is performed in at least one of the databases, retrieval data for the asset information of the customer are newly associated with the identifier to constitute the integrated identification information.

16. A data structure of integrated identification information for asset information management, wherein retrieval data for each customer, which are used in a plurality of databases in which different kinds of asset information is registered, are associated with a single identifier unique to said each customer.

17. The data structure according to claim 16, wherein the identifier is created according to a code different from that of the retrieval data in said each database, and wherein
every time a new customer registration is performed in at least one of the databases, retrieval data for the asset information of the customer are newly associated with the identifier to constitute the integrated identification information.

18. A computer readable recording medium that records integrated identification information for use in asset information management, said integrated identification information having a data structure in which retrieval data for each customer, which are used in a plurality of databases in which different kinds of asset information is registered, are associated with a single identifier unique to said each customer.

19. The computer readable recording medium according to claim 18, wherein the identifier is created according to a code different from that of the retrieval data in said each database, and wherein
every time a new customer registration is performed in at least one of the databases, retrieval data for the asset information of the customer are newly associated with the identifier to constitute the integrated identification information.
